(19) United States
(12) Patent Application Publication
(10) Pub. No.: US 2026/0221642 A1
(43) Pub. Date: Jul. 30, 2026

(54) ANTENNA AND SECTOR FRAME MOUNTING SYSTEM

(71) Applicant: Outdoor Wireless Networks LLC, Richardson, TX (US)

(72) Inventors: Samantha L. Merta, Richardson, TX (US); Jared Haines, Rock City Falls, NY (US)

(21) Appl. No.: 19/143,591

(22) PCT Filed: Jan. 10, 2024
(86) PCT No.: PCT/US2024/010972

§ 371 Date: Jun. 26, 2025

Related U.S. Application Data
(60) Provisional application No. 63/480,218, filed on Jan. 17, 2023.

(51) Int. Cl. H01Q 1/12; H01Q 1/00; H01Q 1/24

(52) U.S. Cl. CPC H01Q 1/1228; H01Q 1/002; H01Q 1/246

(57) ABSTRACT

An antenna mounting system with a three-sector mounting assembly configured to mount to an antenna tower or monopole; a plurality of horizontal poles mounted to the antenna tower or monopole, at least two, spaced apart in a longitudinal direction, for each of the three sectors; and a plurality of antennas, at least two for each sector, each antenna having a mounting structure or mounting structures directly attached to a respective two of the plurality of horizontal poles. The only vertical poles used are spaced apart from the antennas. The antennas may be base station antennas, optionally with active antenna units.

### RELATED APPLICATIONS

This patent application claims the benefit of and priority to U.S. Provisional Application Ser. No. 63/480,218, filed Jan. 17, 2023, the contents of which are hereby incorporated by reference as if recited in full herein.

### FIELD OF THE INVENTION

The present invention relates generally to antenna mounting systems, and more particularly to mobile communications site mounting systems.

### BACKGROUND

Various types of towers have been constructed for the purpose of supporting one or more antennas, such as those for broadcasting television and radio signals. Some towers are specifically designed for transmitting and receiving cellular telephone signals and other types of radio frequency (RF) signals. Typically, RF towers are tall, self-supporting structures of one of two types: lattice towers and tubular monopole towers.

RF towers are often designed to allow a person to climb to the top and remain there to install and/or repair RF antennas (e.g., cellular antennas) and other equipment connected to the tower. Platforms are typically mounted near the tops of RF towers (e.g., cellular towers) for supporting workers who may be responsible for installing and/or maintaining RF antennas (e.g., cellular antennas). Such platforms are designed to support the weight of a human and may also be used to support a number of the RF antennas.

Exemplary platforms are described in U.S. Patent Publication No. 2011/0279347 to Pass et al., the disclosure of which is hereby incorporated herein in its entirety. The platform described in Pass et al. is a so-called “six-sector” platform. Most antenna arrangements include antennas that face away from the tower in three different directions separated by 120 degrees. Recently, in the interest of increasing antenna density, some six-sector arrangements have been deployed, in which antennas are directed in six different directions at 60 degree intervals.

Many sector frames include both horizontal and vertical poles and the antennas are directly attached at three locations to the vertical poles.

The sector frames may be designed or use combinations of horizontal and vertical support poles and provide a platform for ease of installation/servicing. See, U.S. Pat. No. 11,462,813, to Palmer et al., the contents of which are also incorporated herein in its entirety.

Many sector frames and antenna mounting systems are provided as site-specific configurations using parts from different manufacturers resulting in little standardization and a relatively large numbers of parts which may result in increased weight, PIM sources and the like. With the advent of 5G base station antennas, the weight and loading introduced by these devices may require some towers to be modified to accommodate the additional weight, which can be costly.

Based on the foregoing, it may be desirable to provide sector frame and base station antenna mounting configurations that facilitate installation and reduce required parts and weight, with the ability to mount two-three antennas per sector.

### SUMMARY

As a first aspect, embodiments of the invention are directed to integrated antenna mounting systems configured to couple to a (monopole) tower or other target mounting structure. The mounting systems can include three sets of horizontal poles, one set for each of three sectors. The system can include two-three antennas, optionally base station antennas, that are directly attached to each (pair) of the three sets of horizontal poles.

Other embodiments provide the sector frame for one or two sectors, rather than three sectors.

The antenna mounting system can mount to a roof, wall, pole or tower.

The mounting system can be devoid of vertical mounting poles that attach directly to the (base station) antennas whereby the horizontal poles provide the structural mounting interface for the antennas and any vertical poles provide structural support but are spaced apart from the antennas.

Each base station antenna can include an active antenna module behind a base station antenna radome and in front of a respective set of the horizontal poles.

The active antenna module can be configured to attach to the base station antenna.

The active antenna module can be configured to attach to one of the horizontal pairs of poles directly or indirectly via a secondary shorter horizontal pole that is below one of the pairs of the horizontal poles.

A platform can be coupled to a mounting member of the mounting system.

The mounting system can be provided without a platform.

Embodiments of the present invention are directed to an antenna mounting system that includes: a three-sector mounting assembly configured to mount to an antenna tower or monopole and having a plurality of horizontal poles configured to mount to the antenna tower or monopole, at least two, spaced apart in a longitudinal direction, for each of the three sectors; and a plurality of antennas, at least two for each sector, each antenna including a mounting structure or mounting structures directly attached to a respective two of the plurality of horizontal poles.

At least some of the antennas can be base station antennas.

At least some of the base station antennas can have a respective active antenna module that resides behind a base station antenna radome of the base station antennas and in front of a respective pair of the horizontal poles.

The active antenna module can be configured to attach to a corresponding base station antenna thereby attaching to the horizontal poles only via the mounting structure attached to the antennas and the horizontal poles.

The active antenna module can be configured to directly or indirectly attach to one of the horizontal poles.

The system can include a platform coupled to at least some of the horizontal poles.

The system can include vertical poles attached to the plurality of horizontal poles but only at locations spaced apart from the antennas.

The three-sector mounting assembly can be configured to reside at a top portion of the antenna tower or monopole.

Other aspects of the present invention are directed to methods of mounting antennas to a target mounting structure. The methods include: providing antennas with mounting structures attached to a rear surface thereof; providing a tri-sector mounting assembly that has at least six horizontal poles; attaching two to three of the antennas to a respective two of the six horizontal poles to provide an integrated antenna and tri-sector mounting assembly; hoisting the integrated antenna and tri-sector mounting assembly into position on a tower or monopole; and attaching the integrated antenna and tri-sector mounting assembly to the tower or monopole.

The antennas can be or include base station antennas.

At least some of the base station antennas can have active antenna units.

Still other aspects of the invention are directed to an antenna mounting system that includes: a mounting assembly configured to mount to a target structure and having a plurality of horizontal poles configured to mount to the target structure, at least two horizontal poles being spaced apart in a longitudinal direction; and a plurality of antennas, each antenna having a mounting structure or mounting structures directly attached to a respective two of the plurality of horizontal poles.

At least some of the antennas can be base station antennas.’

At least some of the base station antennas can have a respective active antenna module residing behind a base station antenna radome and in front of a respective pair of the horizontal poles.

The system can include a platform coupled to at least some of the horizontal poles.

The system can include vertical poles attached to the plurality of horizontal poles but only at locations spaced apart from the antennas.

The mounting assembly can be configured to reside at a top portion of an antenna tower or monopole as the target structure.

The mounting structure can have a vertical member that has curved contact surfaces facing and abutting against a respective horizontal pole.

### BRIEF DESCRIPTION OF THE FIGURES

FIG. 1A is a side perspective view of a portion of an antenna mounting system according to embodiments of the invention.

FIG. 1B is a side perspective view of a larger portion of the antenna mounting system shown in FIG. 1A.

FIG. 2 is a perspective schematic view of another embodiment of an antenna mounting assembly according to embodiments of the present invention.

FIG. 3 is a side view of the antenna mounting assembly of FIG. 2.

FIG. 4 is a perspective schematic view of a portion of an antenna mounting assembly according to embodiments of the present invention.

FIG. 5 is a perspective view of a tri-sector antenna and sector mounting assembly with two base station antennas per sector according to embodiments of the present invention.

FIG. 6 is a perspective view of a tri-sector antenna and sector mounting assembly with three base station antennas per sector according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

Also, as used herein, the terms “horizontal” and “vertical” are intended to encompass structures that may vary from precise horizontal or vertical orientations by a small amount (e.g., 5-10 degrees).

It will also be understood that, as used herein, the terms “example,” “exemplary,” and derivatives thereof are intended to refer to non-limiting examples and/or variants embodiments discussed herein and are not intended to indicate preference for one or more embodiments discussed herein compared to one or more other embodiments.

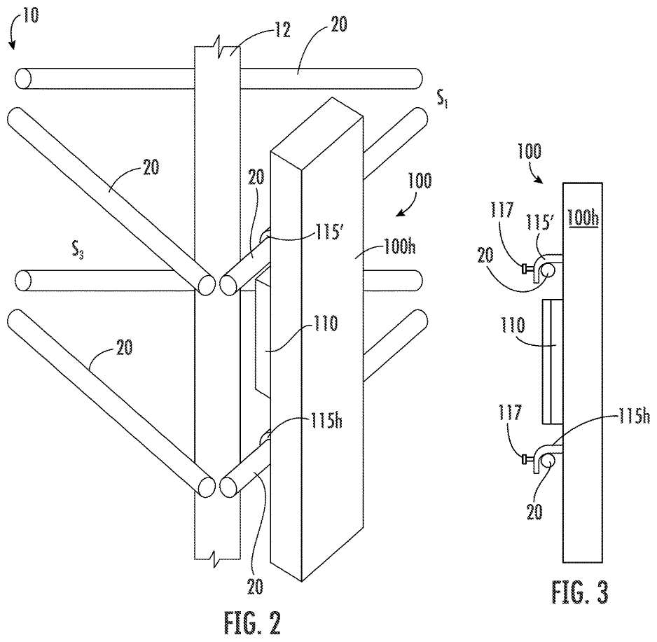

Referring now to the drawings, an antenna mounting assembly 10 is shown. Where used as a tri-sector mounting system, the mounting assembly 10 comprises a plurality of horizontal poles 20, at least two in each sector S of the three sectors, S₁, S₂, S₃ (FIG. 3). Typically, a pair 20p of the horizontal poles 20 are used to mount at least two laterally spaced apart antennas 100. That is, each antenna 100 is directly mounted to at least one horizontal pole, shown as to first and second horizontal poles 20₁, 20₂ that are longitudinally spaced apart rather than to the vertical poles 30. The vertical poles 30, where used, can provide structural support for the mounting assembly 10 but are spaced apart from each of the antennas 100. The vertical poles 30 can also provide longitudinal, positional adjustment of the horizontal poles 20, and hence the base station antennas 100.

It is also contemplated that the antenna mounting system 10 can be configured to be used for single sector or dual sector arrangements and/or for roof top or wall mounting structures.

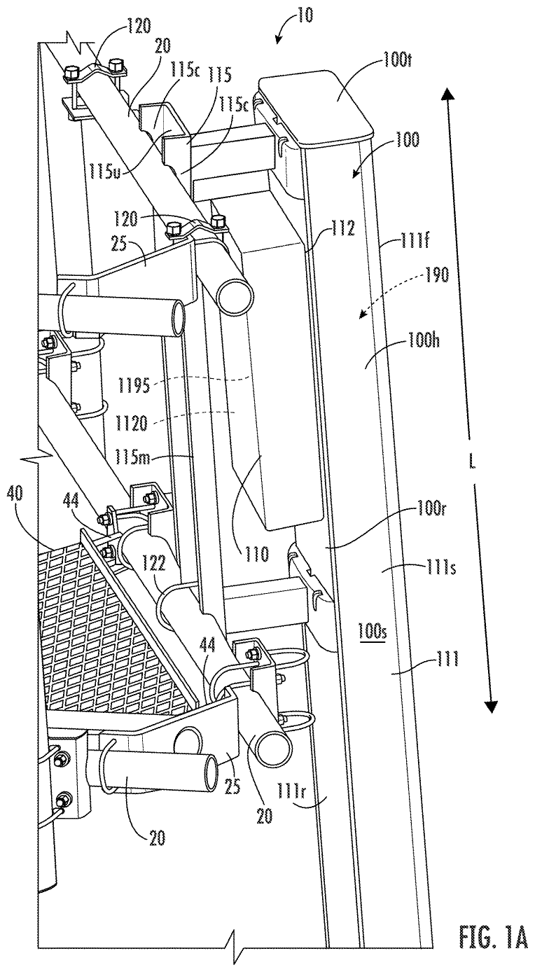

Referring to FIGS. 1A, 1B, 2, 5 and 6, no vertical poles 30 are required to be aligned with a longitudinally extending centerline of the housing 100h. Also, no vertical poles 30 are used to directly attach to the base station antennas 100 and two mounting connections rather than three can be used to attach the base station antenna 100 to the two horizontal poles 20₁, 20₂, each of which may eliminate weight and reduce PIM regions relative to conventional mounting systems.

The antenna 100 may be a base station antenna or other antenna. If a base station antenna 100 then it may be a passive antenna alone without requiring an active antenna or can comprise an active antenna unit 110.

The antenna 100 can have a mounting structure 115 with an elongate member 115m that attaches to the first and second horizontal poles 20₁, 20₂. The elongate member 115m can have curved abutting surfaces 115c that slidably contacts the pole across a shaped channel 115u, which can be an open shaped channel such as a generally “U” shaped channel.

Referring to FIG. 1A, one or more top attachment members 120 and one or more bottom attachment members 122 can be used to attach the mounting structure 115, and hence the antenna housing 100h, to the longitudinally spaced apart horizontal poles 20₁, 20₂.

As shown in FIGS. 1A and 1B, coupling structures 25 can be used to attach end portions of adjacent horizontal poles 20. The coupling structures 25 can be planar metal brackets or have other configurations.

The radius of curvature of the curved abutting surfaces 115c of the mounting structure 115 can be the same or different as that of the radius of curvature of the horizontal pole(s) 20₁, 20₂.

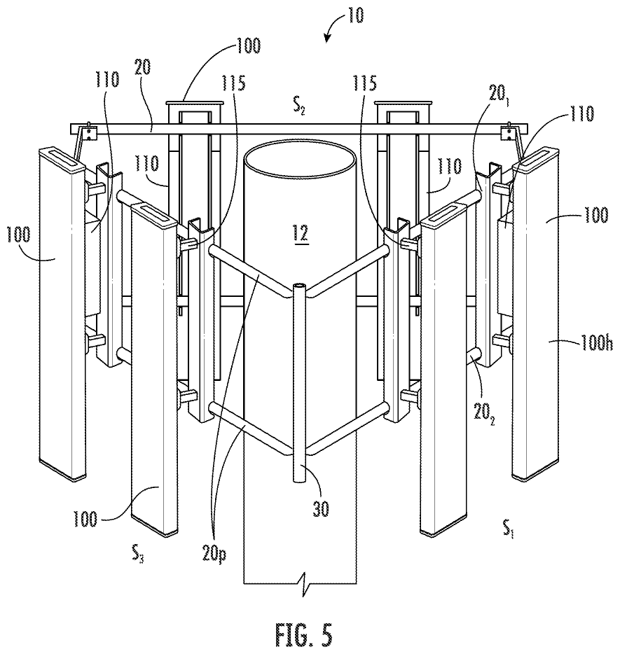

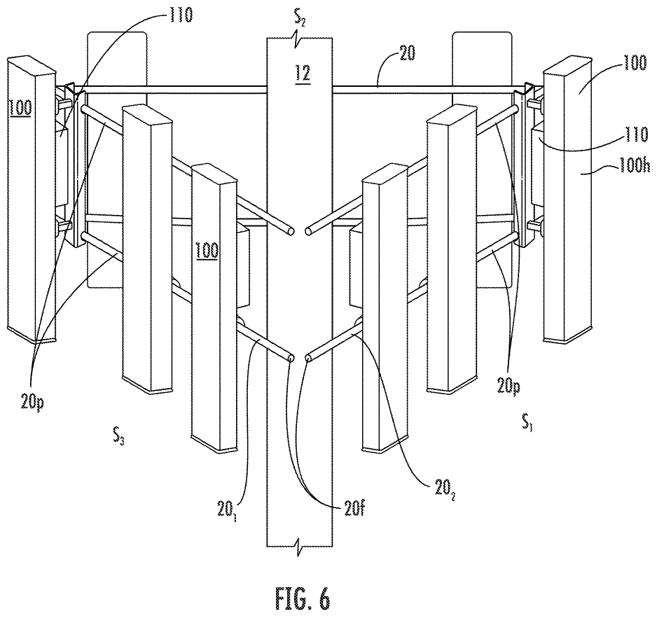

FIG. 1A shows that the curved surfaces 115c can extend rearward to terminate at or in front of an axially extending centerline of the horizontal pole 20₁, 20₂ thereat. FIGS. 5 and 6 show that the curved surfaces 115c can extend rearward to terminate in-line with or rearward of an axially extending centerline of the horizontal pole 20₁, 20₂ thereat.

Referring to FIGS. 1A and 1B, an optional platform 40, such as a metal mesh platform, can be directly attached to at least one of the horizontal poles 20 using mounting brackets 44. As shown in FIG. 1B, one side of the platform 40 can attach to one pole 20 and another side can have an arm 40 that extends inwardly to support a bracket 48 that couples to an outer surface of the tower or monopole 12.

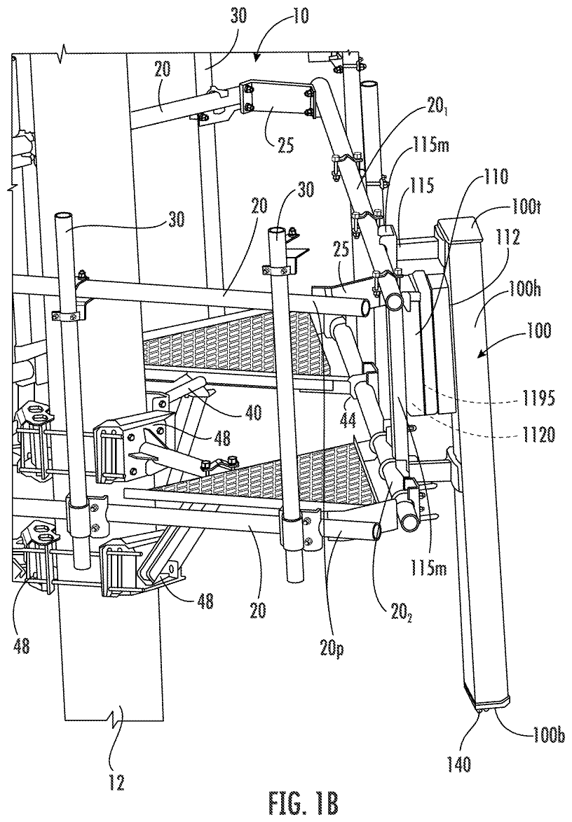

FIGS. 2 and 3 are schematic illustrations of another embodiment of a mounting system 10 with horizontal poles 20 attached to a respective antenna 100. The mounting structure 115′ can be provided by cooperating hooks 115h and latches 117.

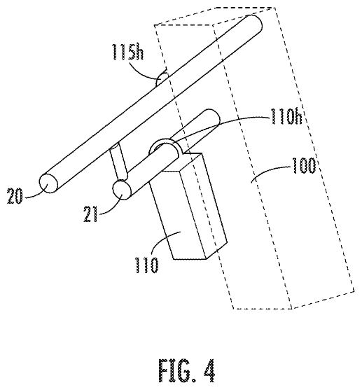

FIG. 4 is a schematic illustration showing that the active antenna unit 110 can be attached to one of the horizontal poles 20 via a secondary shorter pole 21 and using a hook 110h or other attachment members. An active antenna unit 110 can be attached directly to one of the horizontal poles 20 and is not required to be attached to a corresponding base station antenna housing 100h.

FIG. 5 illustrates the mounting system 10 as a tri-sector mounting system 10 with two base station antennas 100 held directly by a respective two of six horizontal poles 20 with mounting structures 115 providing the corresponding attachments thereto. A vertical pole 30 can attach ends of adjacent horizontal poles 20.

FIG. 6 illustrates the mounting system 10 as a tri-sector mounting system 10 with three base station antennas 100 held directly by a respective two of six horizontal poles 20 with mounting structures 115 providing the corresponding attachments thereto. Ends of adjacent and horizontally aligned horizontal poles 20 can be spaced apart and not attached to define free ends 20f.

FIGS. 5 and 6 also illustrate no platform 40 may be required and the mounting assembly 10 can be affixed to the tower using pole mounts/clamps.

It is contemplated that antennas 100 can be mounted to a target mounting structure in a manner that provides easier installation with less in the airtime demands for installers relative to conventional mounting systems, particularly for tri-sector base station antenna systems. The methods can include: providing antennas with mounting structures attached to a rear surface thereof; providing a tri-sector mounting assembly comprising six horizontal poles; attaching two to three of the antennas to a respective two of the six horizontal poles to provide an integrated antenna mounting assembly; hoisting the integrated antenna and mounting assembly into position on a tower or monopole; and attaching the integrated antenna mounting assembly to the tower or monopole.

Turning again to FIGS. 1A and 1B, an example antenna is shown as an example base station antenna 100 according to certain embodiments of the present invention. In the description that follows, the base station antenna 100 will be described using terms that assume that the base station antenna 100 is mounted for use on a tower, pole or other mounting structure with the longitudinal axis L of the base station antenna 100 extending along a vertical axis and the front of the base station antenna 100 mounted opposite the tower, pole or other mounting structure pointing toward the target coverage area for the base station antenna 100 and the rear 100r of the base station antenna 100 facing the tower or other mounting structure. It will be appreciated that the base station antenna 100 may not always be mounted so that the longitudinal axis L thereof extends along a vertical axis. For example, the base station antenna 100 may be tilted slightly (e.g., less than 10°) with respect to the vertical axis so that the resultant antenna beams formed by the base station antenna 100 each have a small mechanical downtilt.

The base station antenna 100 can couple to or include at least one active antenna module 110. The term “active antenna module” is used interchangeably with “active antenna unit” and “AAU” and “active antenna” and refers to a cellular communications unit comprising radio circuitry and associated radiating elements. The radio circuitry is capable of electronically adjusting the amplitude and/or phase of the subcomponents of an RF signal that are output to different radiating elements of an array or groups thereof. The active antenna module 110 comprises the radio circuitry and the radiating elements (e.g., a multi-input-multi-output (mMIMO) beamforming antenna array) and may include other components such as filters, a calibration network, an antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front to back direction of the base station antenna 100, with radiating elements 1195 closer to the front radome 111 f of the housing 100h/radome 111 of the base station antenna 100 than radio circuitry unit 1120. In some embodiments, the radiating elements 1195 may comprise a separate sub-unit from the radio circuitry and the radiating element sub-unit may be mounted within the base station antenna 100 instead of being external to the base station antenna 100. The AAU radiating elements 1195 can be provided or comprise mMIMO radiating elements.

The base station antenna 100 includes an antenna assembly 190, which can be referred to as a “passive antenna assembly”. The term “passive antenna assembly” refers to an antenna assembly having arrays of radiating elements that are coupled to radios that are external to the antenna, typically remote radio heads that are mounted in close proximity to the base station antenna 100. The arrays of radiating elements included in the passive antenna assembly 190 are configured to form static antenna beams (e.g., antenna beams that are each configured to cover a sector of a base station). The passive antenna assembly 190 can comprise a reflector with radiating elements projecting in front of the reflector and the radiating elements can include one or more linear arrays of low band radiating elements that operate in all or part of the 617-960 MHz frequency band and/or one or more linear arrays of mid-band radiating elements that operate in all or part of the 1427-2690 MHz frequency band. The passive antenna assembly 190 is mounted in the housing 100h of base station antenna 100 and one or more active antenna modules 110 can optionally releasably (detachably) couple (e.g., directly or indirectly attach) to base station antenna 100. See, e.g., U.S. Pat. No. 11,482,774 and U.S. patent application Ser. No. 17/787,619, the contents of which are hereby incorporated by reference as if recited in full herein.

The base station antenna 100 has a housing 100h. The housing 100h may be substantially rectangular with a flat rectangular cross-section. The housing 100h may be provided to define at least part of a radome 111 with at least the front side 111f configured as a dielectric cover that allows RF energy to pass through in certain frequency bands. The housing 100h may also be configured to that the rear 100r defines a rear side 111r radome opposite the front side radome 111f. Optionally, the housing 100h and/or the radome 111 can also comprise two (narrow) sidewalls 100s, 111s facing each other and extending rearwardly between the front side 111f and the rear side 111r. Typically, the top side 100t of the housing 100h may be sealed in a waterproof manner and may comprise an end cap and the bottom 100b of the housing 100h may be sealed with a separate end cap. The front side 111f, the sidewalls 111s and typically at least part of the rear side 111r of the radome 111 are substantially transparent to radio frequency (RF) energy within the operating frequency bands of the base station antenna 100 and active antenna module 110. The radome 111 may be formed of, for example, fiberglass or plastic.

Still referring to FIGS. 1A, 1B, in some embodiments, an active antenna module 110 can attach to the base station antenna 100 using at least one accessory mounting bracket 112. The rear 111r of the housing 100h may be a flat surface extending along a common plane over an entire longitudinal extent thereof or along at least a portion of the longitudinal extent thereof.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An antenna mounting system, comprising:
a three-sector mounting assembly configured to mount to an antenna tower or monopole and comprising a plurality of horizontal poles configured to mount to the antenna tower or monopole, at least two, spaced apart in a longitudinal direction, for each of the three sectors; and
a plurality of antennas, at least two for each sector, each antenna comprising a mounting structure or mounting structures directly attached to a respective two of the plurality of horizontal poles.

2. The system of claim 1, wherein at least some of the antennas are base station antennas.

3. The system of claim 2, wherein at least some of the base station antennas comprise a respective active antenna module residing behind a base station antenna radome of the base station antennas and in front of a respective pair of the horizontal poles.

4. The system of claim 3, wherein the active antenna module is configured to attach to a corresponding base station antenna.

5. The system of claim 3, wherein the active antenna module is configured to directly or indirectly attach to one of the horizontal poles.

6. The system of claim 1, further comprising a platform coupled to at least some of the horizontal poles.

7. The system of claim 1, further comprising vertical poles attached to the plurality of horizontal poles but only at locations spaced apart from the antennas.

8. The system of claim 1, wherein the three-sector mounting assembly is configured to reside at a top portion of the antenna tower or monopole.

9. The system of claim 1, wherein the mounting structure or the mounting structures comprises a vertical member that has curved contact surfaces facing and abutting against a respective horizontal pole.

10. The system of claim 9, wherein the vertical member has a length that is greater than a length of an active antenna module residing behind at least some of the antennas.

11. A method of mounting antennas to a target mounting structure, comprising:
providing antennas with mounting structures attached to a rear surface thereof;
providing a tri-sector mounting assembly comprising six horizontal poles;
attaching two to three of the antennas to a respective two of the six horizontal poles to provide an integrated antenna and tri-sector mounting assembly;
hoisting the integrated antenna and tri-sector mounting assembly into position on a tower or monopole; and
attaching the integrated antenna and tri-sector mounting assembly to the tower or monopole.

12. The method of claim 11, wherein the antennas are base station antennas.

13. The method of claim 12, wherein at least some of the base station antennas comprise active antenna units.

14. An antenna mounting system, comprising:
a mounting assembly configured to mount to a target structure and comprising a plurality of horizontal poles configured to mount to the target structure, at least two horizontal poles being spaced apart in a longitudinal direction; and
a plurality of antennas, each antenna comprising a mounting structure or mounting structures directly attached to a respective two of the plurality of horizontal poles.

15. The system of claim 14, wherein at least some of the antennas are base station antennas.

16. The system of claim 14, wherein at least some of the base station antennas comprise a respective active antenna module residing behind a base station antenna radome and in front of a respective pair of the horizontal poles.

17. The system of claim 14, further comprising a platform coupled to at least some of the horizontal poles.

18. The system of claim 14, further comprising vertical poles attached to the plurality of horizontal poles but only at locations spaced apart from the antennas.

19. The system of claim 14, wherein the mounting assembly is configured to reside at a top portion of an antenna tower or monopole as the target structure.

20. The system of claim 14, wherein the mounting structure comprises a vertical member that has curved contact surfaces facing and abutting against a respective horizontal pole.
